(19) United States
(12) Patent Application Publication
(10) Pub. No.: US 2018/0063428 A1
(43) Pub. Date: Mar. 1, 2018

(54) SYSTEM AND METHOD FOR VIRTUAL REALITY IMAGE AND VIDEO CAPTURE AND STITCHING

(71) Applicant: ORBI, Inc., Lewes, DE (US)

(72) Inventors: Iskander Rakhmanberdiyev, Almaty (KZ); Adil Suranchin, Almaty (KZ)

(73) Assignee: ORBI, Inc.

(21) Appl. No.: 15/254,878

(22) Filed: Sep. 1, 2016

(51) Int. Cl. H04N 5/232; H04N 5/265; H04N 5/04; G06F 3/16

(52) U.S. Cl. CPC H04N 5/23238; G06F 3/16; H04N 5/04; H04N 5/265

(57) ABSTRACT

Systems and methods are provided for capturing visual data for virtual reality systems. The systems and methods include acquiring visual data captured by visual sensors, storing the acquired visual data in the memory, and providing the visual data stored in the memory for combining into a combined visual representation of the visual data. The disclosed systems and methods can combine visual representation based on synchronizing the visual data, determining matching portions of the fields of view contained in the visual data, and matching portions of the fields of view.

### BACKGROUND

The increased availability of virtual reality systems and systems that can display 360 degree content has created an increasing demand for capturing 360 degree scenes. This demand has resulted in the development of 360 degree cameras, either attachable or handheld. Handheld cameras available in the market typically include fisheye lenses that extremely distort whatever is closest to the lens. Other cameras make use of a monopod, but when utilizing a monopod, the user does not have freedom to use both hands while capturing the 360 degree scene. Attachable cameras, coupled to a bike, helmet, or hanging from the ceiling, are limited in that they do not provide practical benefit. Namely, these cameras are a challenge to learn to set up, use, and share the 360 degree videos they capture. These cameras also require an additional mount piece for proper attachment. Moreover, none of the 360 degree cameras available in the market provide a true first person perspective. Existing cameras capture the user who occupies a considerable portion of the scene. There exists a need for an easy to use 360 degree content capturing system that captures clear, 360 degree content from a first person perspective.

### BRIEF DESCRIPTION OF THE DRAWINGS

Reference will now be made to the accompanying drawings showing example embodiments of this disclosure. In the drawings:

FIG. 1A is an exemplary front view of an apparatus for capturing visual data for virtual reality systems.

FIG. 1B is an exemplary left side view of apparatus for capturing visual data for virtual reality systems.

FIG. 1C is an exemplary right side view of apparatus for capturing visual data for virtual reality systems.

FIG. 1D is an exemplary top view of apparatus for capturing visual data for virtual reality systems.

FIG. 1E is an exemplary rear view of apparatus for capturing visual data for virtual reality systems.

FIG. 2 is a block diagram of an exemplary system for capturing visual data for virtual reality systems, consistent with embodiments of the present disclosure.

FIG. 3 is a block diagram of an exemplary computing device, consistent with embodiments of the present disclosure.

FIG. 4 is a flowchart of an exemplary method for capturing and processing content, consistent with embodiments of the present disclosure.

FIG. 5 is a flowchart of an exemplary method for capturing content, consistent with embodiments of the present disclosure.

### DETAILED DESCRIPTION

Reference will now be made in detail to the exemplary embodiments implemented according to the present disclosure, the examples of which are illustrated in the accompanying drawings. Wherever possible, the same reference numbers will be used throughout the drawings to refer to the same or like parts.

The embodiments described herein relate to image and video capture and stitching. Increasing systems are being created that are capable of consuming 360 degree content. There is currently a limited library of 360 degree content for these systems. Many domains, ranging from activities such as action sports to recreational activity at panoramic sites, are ideal for capturing this type of content. This has led to an increased demand for 360 degree cameras. Some systems have attempted to meet the public's demands, for example, the Samsung 360, LG 360, Kodak 5V360, SV2 360, Regal Beta, Zeta 5, and VUVL. But each of these systems include drawbacks. Some methods for establishing 360 degree images employ a handheld camera that include a fisheye lens, distorting whatever is closest to the camera. Additionally, because the length of the user's arm or recording apparatus is limited, the user of these cameras is typically in close proximity to the camera sensor itself and occupies a significant portion of the frame. Other handheld cameras utilize a monopod which extends the camera further out from the user, but limits the user's ability to use both hands and still results in the user obscuring portions of the frame.

In order to attain first person view in the captured image, the image must capture exactly what the user is seeing as well as the surrounding area without obstruction. The embodiments disclosed herein provide an improved system for capturing this type of content. Instead of employing a camera that captures images and videos from a perspective apart from the user, the disclosed systems and methods capture content from the exact perspective the user is seeing. The embodiments described herein can include camera sensors embedded in glasses wearable by a user that capture content in every direction. The disclosed system and methods can include, for example, glasses, sunglasses, sport goggles, helmets, hats, headgear, or headbands.

The disclosed system and methods can capture clear and well-stitched scenes due to overlapping images produced by each camera sensor. In some embodiments, consistent with the present disclosure, each of four camera sensors can include at least a 110 degree field of view, vertically and horizontally, that can capture overlapping fields of view and allow for the assembly of a 360 degree image or video. In yet other embodiments consistent with the present disclosure, the system and methods can include more camera sensors or as few as one camera sensor. Accordingly, changes in the physical structure of the device, including the number of camera sensors, can result in changes in the size and/or dimensions of the captured fields of view. The overlapping portion of the captured images or video can allow for the production of clear 360 degree images and video. In some embodiments, an overlap of at least 5 degrees in the fields of view of the various cameras can be used for assembly of the fields of view into a combined image or video. The systems disclosed can stitch scenes for viewing on virtual reality devices. The technologies disclosed herein can utilize the information in the captured image and video streams as well as data from the system itself to correct for jitter, shaking, and/or jerky movement of the camera sensors to provide clear and stabilized video.

When viewed, not only can the user see the same view as the original individual who captured the image or video, but the user can look around in the scene to experience fields of view in any possible direction. Accordingly, the viewer can experience the same viewpoint as the original photographer, while also experiencing the scene or action in their own way. In other embodiments, the combined video or image data can be viewed on any medium used to display data, and can allow for only a portion of the 360 degree image or video to be displayed to accommodate the display apparatus.

Through this process, users of the system can create high quality 360 degree images and videos without the challenges associated with current systems. The embodiments described herein further include acquiring visual data captured by visual sensors, storing the acquired visual data in the memory, and providing the visual data stored in the memory for combining into a combined visual representation of the visual data. The disclosed systems and methods can combine visual representation based on synchronizing the visual data, determining matching portions of the fields of view contained in the visual data, and matching portions of the fields of view.

In additional embodiments, the systems and methods disclosed further include utilizing a specific algorithm for stabilization and stitching. In yet other embodiments consistent with the present disclosure, the system and methods can include a non-transitory computer readable medium to cover subject matter disclosed.

The embodiments described herein can apply to many fields. Descriptions and applications related to specific domains do not preclude the application of the described embodiments to other technologies or fields.

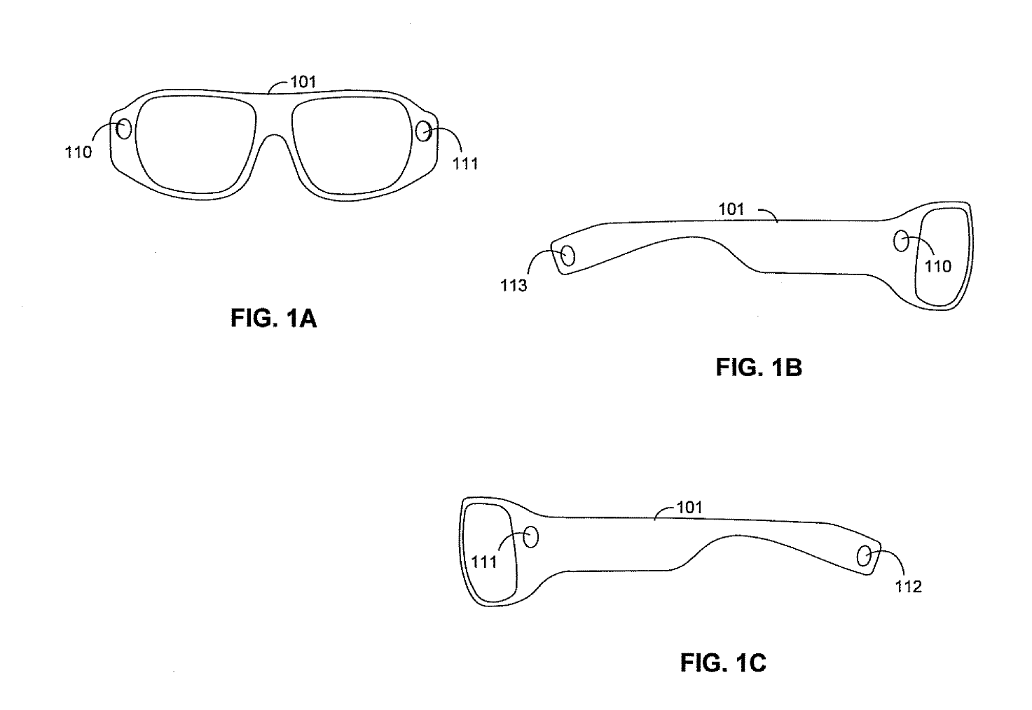

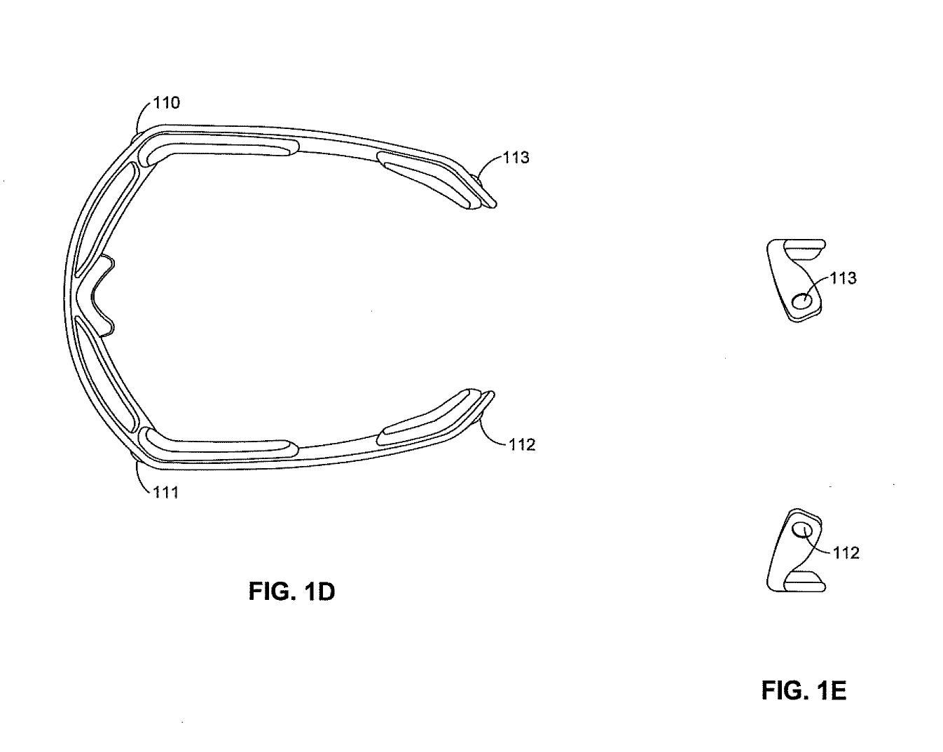

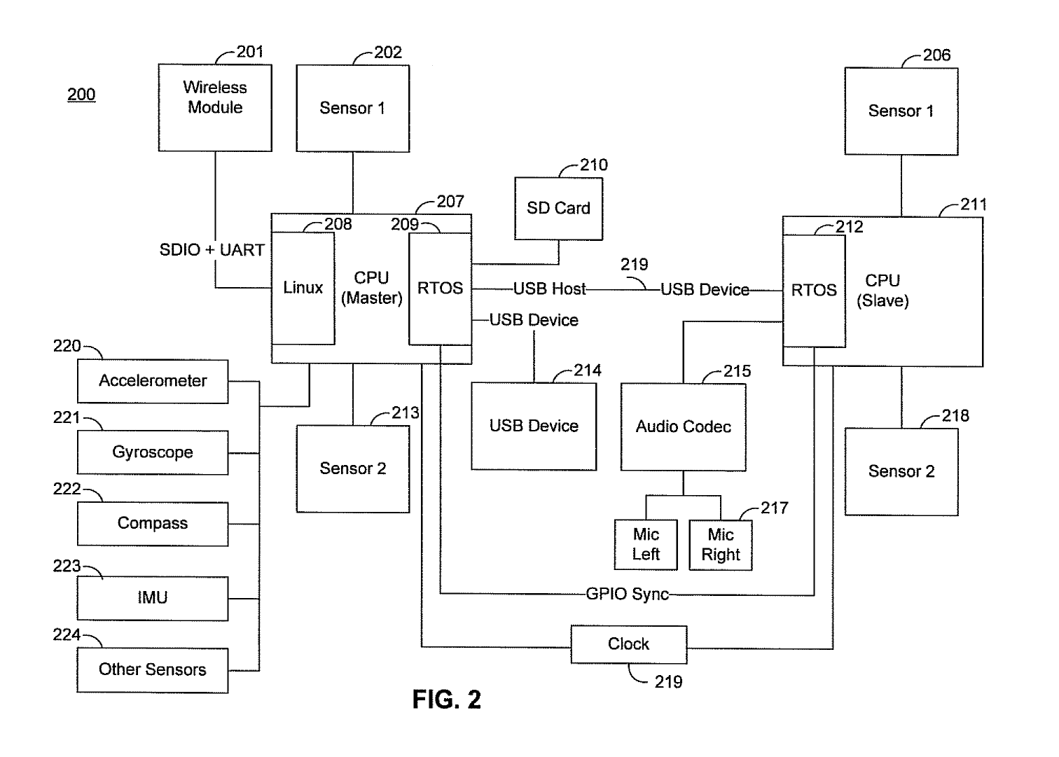

FIGS. 1A-1E are exemplary views of an apparatus for capturing visual data for virtual reality systems. In some embodiments, the apparatus can be a pair of glasses as shown in FIGS. 1A-1E. As shown the glasses can include a plurality of camera sensors and can include a variety of configurations. The use of a pair of glasses in FIGS. 1A-1E is exemplary. A variety of different headgear, such as, among others, sunglasses, sport goggles, helmets, hats, headgear, or headbands could be used. In some embodiments, the apparatus used can include additional bands, straps or other mechanisms to help the apparatus remain in place. Glasses 101 can also include sensors for detecting motion and other environmental conditions. These sensors can be connected to accelerometer 220, gyroscope 221, compass 222, inertial measurement unit (IMU) 223, and other measuring sensors 224 (e.g., for exposure and white balance) described in more detail related to FIG. 2 below. In some embodiments, these readings can be taken at 60 readings per second or 2 readings for every frame of video to provide additional granularity in the measurements.

FIG. 1A is an exemplary front view of an apparatus for capturing visual data for virtual reality systems. The glasses 101 can be worn by a user and can include four built-in cameras. In some embodiments, there can be more cameras or as few as one. As shown in FIG. 1A, when looking directly at the user, there are two visible cameras. Camera 110 can be the front left camera sensor and camera 111 can be the front right camera sensor. Each camera, including those visible in FIG. 1A and those that are visible in the additional perspectives of glasses 101, can be protected by a thin plastic coating or other material intended to protect the camera. The protective material can include any materials suitable to protect the camera lenses while still allowing proper functioning of the cameras (e.g., cameras 110 and 111 as well as cameras shown in the additional figures).

FIG. 1B is an exemplary left side view of an apparatus for capturing visual data for virtual reality systems. As shown in FIG. 1B, when viewing the left side of glasses 101, there can be two visible cameras. Camera 110, also visible in FIG. 1A, can be the front left camera sensor and camera 113 can be the rear left camera sensor.

FIG. 1C is an exemplary right side view of an apparatus for capturing visual data for virtual reality systems. As shown in FIG. 1C, when viewing the right side of glasses 101, there can be two visible cameras. Camera 111, also visible in FIG. 1A, can be the front right camera sensor and camera 112 can be the rear right camera sensor.

FIG. 1D is an exemplary top view of an apparatus for capturing visual data for virtual reality systems. As shown in FIG. 1D, when viewing the top of glasses 101, there are four visible cameras. Cameras 110 and 111, also visible in FIG. 1A, can be the front left camera sensor and the front right camera sensor, respectively, camera 112, also visible in FIG. 1C, can be the rear right camera sensor, and camera 113, also visible in FIG. 1B, can be the rear left camera sensor.

FIG. 1E is an exemplary rear view of an apparatus for capturing visual data for virtual reality systems. As shown in FIG. 1E, when viewing the rear of glasses 101, there can be two visible cameras. Camera 112 can be the rear right camera sensor, as shown in FIGS. 1C and 1D, and camera 113 can be the rear left camera sensor, as shown in FIGS. 1B and 1D.

FIG. 2 is a block diagram of an exemplary system 200 for capturing visual data for virtual reality systems, consistent with embodiments of the present disclosure. System 200 can represent hardware components embedded in an apparatus such as that shown in FIGS. 1A-1E. Accordingly, some of the components shown in FIG. 2 can be associated with the components shown in FIGS. 1A-1E. Moreover, FIG. 2 is exemplary and is not intended to preclude additional configurations of components.

Sensor 1 202 and Sensor 2 213 can be associated with the front left and rear left camera sensors of the glasses, respectively. These associations are exemplary. In some embodiments, Sensor 1 202 and Sensor 2 213 can be associated with different cameras in the disclosed apparatus. Sensor 1 206 and Sensor 2 218 can be the front right and rear right camera sensors of the glasses, respectively. These sensors can be coupled to CPU 211. Each CPU includes a RTOS (Real-Time Operating System), such as RTOS 209 and RTOS 212 for processing the content captured by the various camera sensors (e.g., Sensor 1 202, Sensor 2 213, Sensor 1 206 and Sensor 2 218).

System 200 can maintain synchronization between CPUs 207 and 211 as well as between RTOS 209 and 212. RTOS 209 and 212 can synchronize using a GPIO synchronization port. This can be controlled by CPUS 207 and 211, which can maintain synchronization using a shared clock 219. Other mechanisms for synchronization are possible. By synchronizing CPU 207 and 211 and RTOS 209 and 212, the video and audio data captured through the various sensors (e.g., Sensor 1 202, Sensor 2 213, Sensor 1 206 and Sensor 2 218, microphone 216 and microphone 217) can remain synchronized for later processing.

Moreover, CPUs 207 and 211 can be general purpose processing units, can be Graphical Processing Units (GPUs), or can be processing units designed specifically for handling and processing the content captured by Sensor 1 202, Sensor 2 213, Sensor 1 206 and Sensor 2 218. Accordingly, in some embodiments, there can be only one CPU, GPU, or specialized processing unit that is associated with all of the camera sensors (e.g., Sensor 1 202, Sensor 2 213, Sensor 1 206 and Sensor 2 218). In other embodiments there can be one or more CPU, GPU, or specialized processing unit that is associated with each of the camera sensors (e.g., Sensor 1 202, Sensor 2 213, Sensor 1 206 and Sensor 2 218). It is appreciated that different combinations are possible.

As shown in FIG. 2, in some embodiments the system 200 can employ a master-slave model where master CPU 207 has control over slave CPU 211. The connection 219 between RTOS 209 and RTOS 212 can utilize a Universal Serial Bus (USB) host and USB device and allow for communication between CPU 207 and CPU 211. The master CPU 207 can run a Linux 208 module that can connect to peripheral devices such as wireless module 201. The system 200 can use USB or any other communication mechanism to allow RTOS 209 and RTOS 212 to communicate through connection 219.

Data can be transferred from system 200 using a conventional serial data port, a USB device or wirelessly. USB device 214 can transfer the data to another device (e.g., a computer, an iPad, iPhone, Android Phone, Android Table, or other mobile and/or wireless computing device). Wireless module 201 can transfer data to another device using Secure Digital Input Output (SDIO) and Universal Asynchronous Receiver Transmitter (UART) protocols. In other embodiments, additional methods (e.g., Bluetooth or Near Field Communication (NFC) can transfer data to other devices.

Microphones 216 and 217 can further capture audio data. In some embodiments the microphones can capture different audio streams representing different positions, data, or stereo audio feeds. In some embodiments, multiple microphones can capture multiple audio channels. Moreover, in some embodiments, one microphone (e.g., microphone 216) can be adapted to capture low level or low frequency sounds while another microphone (e.g., microphone 217) can be adapted to capture high level or high frequency sounds in order to encompass a full range of audio. Audio codec 215 can decode the audio signals collected by the microphones 216 and 217 and transfer the data to the operating system 212. The audio data captured by microphones 216 and 217 can be shared with other devices in the same way as the video data captured by Sensor 1 202, Sensor 2 213, Sensor 1 206, and Sensor 2 218.

The visual and audio data collected by the sensors and microphones (e.g., Sensor 1 202, Sensor 2 213, Sensor 1 206, and Sensor 2 218, and microphones 216 and 217) can be stored on SD card 210. In some embodiments, the SD card can be removable and used to transfer data to another device with an SD Card reader. In some embodiments, the SD card can be non-removable and remain inside system 200. In some embodiments, a H264 codec memory card can be used so store up to 90 minutes of video recording time on a single battery charge. Additional storage mechanisms are possible and the captured audio and video data can be stored on any non-transitory computer readable medium (e.g., a flexible disk, a hard disk, MO (magneto-optical) drive, a RAM, a PROM, EPROM, FLASH-EPROM or any other flash memory, a cache, a register, any other memory chip or cartridge, or a semiconductor memory) that is part of system 200.

System 200 can further include motion and environmental sensors that can include accelerometer 220, gyroscope 221, compass 222, inertial measurement unit 223, and other environmental sensors 224.

Accelerometer 220 can measure acceleration in glasses 101 of FIG. 1. Accelerometer 220 can detect and monitor vibration in rotating objects. Accelerometer 200 can provide measurements that can be used by CPUs 207 and 211. In some embodiments these measurements can be used for stabilization.

Gyroscope 221 can be a spinning wheel or disc in which the axis of rotation is able to independently take any orientation. When rotating, the orientation of this axis is not affected by tilt or rotation of the mounting, according to the conservation of angular momentum. As a result, gyroscope 221 can be useful for measuring the orientation of glasses 101 of FIG. 1. As with accelerometer 220, the data from gyroscope 221.

Compass 222 can be an instrument used for orientation that measures direction relative to the geographic cardinal directions. Glasses 101 of FIG. 1 can include compass 222 for registering movement of the device and orientation in relation to geographic directions.

IMU 223 can be an electronic device that measures an object's specific force, angular rate, and the magnetic field around the object, using a combination of accelerometers, gyroscopes, and magnetometers.

Other sensors 224 can record additional environmental, atmospheric, or other information. For example other sensors 224 can include a sensor for exposure that detects the amount of light hitting the sensor and ultimately how light or dark a captured image can be. A sensor for white balance or color balance can detect the overall color cast of a captured image.

In some embodiments the sensors described above can be synced between all four camera sensors (e.g., from cameras 110, 111, 112, and 113) of glasses 101. In some embodiments, each camera sensor can have its own set of the above environmental and orientation sensors. These various sensors can be used to better align, stabilize, and otherwise process the images and video captured by the cameras in system 200 and glasses 101.

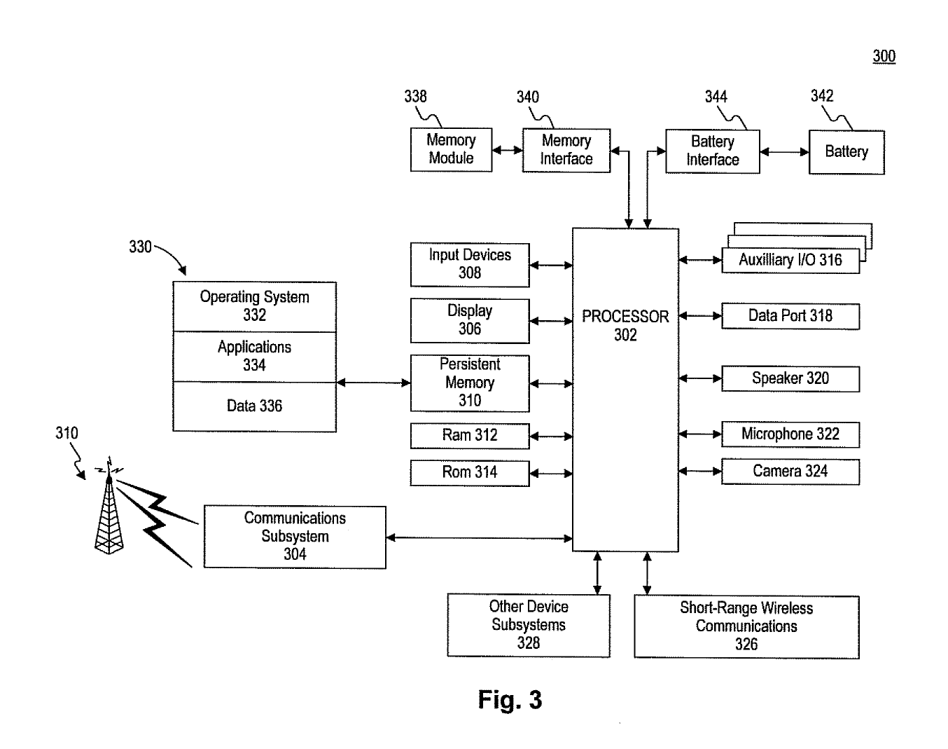

FIG. 3 is a block diagram of an exemplary computing device, consistent with embodiments of the present disclosure. The block diagram illustrates an example electronic device 300. In some embodiments, electronic device 300 can include a communication device having two-way or one-to-many data communication capabilities, audio communication capabilities, and/or video communication capabilities, and the capability to communicate with other computer systems, for example, via the Internet. Depending on the functionality provided by electronic device 300, in various embodiments, electronic device 300 can be a handheld device, a multiple-mode communication device configured for both data and voice communication, a smartphone, a mobile telephone, a laptop, a computer wired to the network, a netbook, a gaming console, a tablet, a smart watch, or a PDA enabled for wireless communication.

Electronic device 300 can include a case (not shown) housing component of electronic device 300. The internal components of electronic device 300 can, for example, be constructed on a printed circuit board (PCB). The description of electronic device 300 herein mentions a number of specific components and subsystems. Although these components and subsystems can be realized as discrete elements, the functions of the components and subsystems can also be realized by integrating, combining, or packaging one or more elements in any suitable fashion.

Electronic device 300 can include a controller comprising at least one processor 302 (such as a microprocessor), which controls the overall operation of electronic device 300. Processor 302 can be one or more microprocessors, field programmable gate arrays (FPGAs), digital signal processors (DSPs), or any combination thereof capable of executing particular sets of instructions. Processor 302 can interact with device subsystems such as a communication subsystem 304 for exchanging radio frequency signals with a wireless network to perform communication functions.

Processor 302 can also interact with additional device subsystems including a communication subsystem 304, a display 306 (e.g., a liquid crystal display (LCD) screen, a touch-screen display, or any other appropriate display), input devices 308 (e.g., a keyboard, a stylus, or control buttons), a persistent memory 310, a random access memory (RAM) 312, a read only memory (ROM) 314, auxiliary input/output (I/O) subsystems 316, a data port 318 (e.g., a conventional serial data port, a Universal Serial Bus (USB) data port, a 30-pin data port, a Lightning data port, or a High-Definition Multimedia Interface (HDMI) data port), a speaker 320, a microphone 322, camera 324, a short-range wireless communications subsystem 326 (which can employ any appropriate wireless (e.g., RF), optical, or other short range communications technology (for example, Bluetooth or NFC)), and other device subsystems generally designated as 328. Some of the subsystems shown in FIG. 3 perform communication-related functions, whereas other subsystems can provide “resident” or on-device functions.

Communication subsystem 304 includes one or more communication systems for communicating with a network to enable communication with social networking services and any external devices (e.g., a server, not shown). The particular design of communication subsystem 304 depends on the wireless network in which electronic device 300 is intended to operate. Electronic device 300 can send and receive communication signals over the wireless network after the required network registration or activation procedures have been completed.

In some embodiments, display 306 can be a touch-screen display. The touch-screen display can be constructed using a touch-sensitive input surface, which is coupled to an electronic controller and which overlays the visible element of display 306. The touch-sensitive overlay and the electronic controller provide a touch-sensitive input device and processor 302 interacts with the touch-sensitive overlay via the electronic controller.

Camera 324 can be a CMOS camera, a CCD camera, or any other type of camera capable of capturing and outputting compressed or uncompressed image data such as still images or video image data. In some embodiments electronic device 300 can include more than one camera, allowing the user to switch, from one camera to another, or to overlay image data captured by one camera on top of image data captured by another camera. Image data output from camera 324 can be stored in, for example, an image buffer, which can be a temporary buffer residing in RAM 312, or a permanent buffer residing in ROM 314 or persistent memory 310. The image buffer can be, for example, a first-in first-out (FIFO) buffer.

Short-range wireless communications subsystem 326 is an additional optional component that provides for communication between electronic device 300 and different systems or devices, which need not necessarily be similar devices. For example, short-range wireless communications subsystem 326 can include an infrared device and associated circuits and components, or a wireless bus protocol compliant communication device such as a Bluetooth® communication module to provide for communication with similarly-enabled systems and devices.

Processor 302 can be one or more processors that operate under stored program control and executes software modules 330 stored in a tangibly-embodied non-transitory computer-readable storage medium such as persistent memory 310, which can be a SD card, register memory, a processor cache, a RAM, a flexible disk, a hard disk, a CD-ROM (compact disk-read only memory), a MO drive, a DVD-ROM (digital versatile disk-read only memory), a DVD RAM (digital versatile disk-random access memory), or other semiconductor memories.

Software modules 330 can also be stored in a computer-readable storage medium such as ROM 314, or any appropriate persistent memory technology, including EEPROM, EAROM, FLASH. These computer-readable storage mediums store computer-readable instructions for execution by processor 302 to perform a variety of functions on electronic device 300. Alternatively, functions and methods can also be implemented in hardware components or combinations of hardware and software such as, for example, ASICs and/or special purpose computers.

Software modules 330 can include operating system software 332, used to control operation of electronic device 300. Additionally, software modules 330 can include software applications 334 for providing additional functionality to electronic device 300. For example, software applications 334 can include applications designed to interface with systems like system 200 above (e.g., software applications 334 can include applications for processing data streams captured by Sensor 1, 202 and 206, Sensor 2, 213 and 218, and microphones 216 and 217 as described above in reference to FIG. 2). For example, software applications 334 can include software designed to combine or stitch the various data streams captured by system 200 into a combined data stream that provides 360 degree content.

Software applications 334 can include a range of applications, including, for example, image and video capture, image and video stitching, virtual reality applications, an e-mail messaging application, an address book, a notepad application, an Internet browser application, a voice communication (i.e., telephony or Voice over Internet Protocol (VoIP)) application, a mapping application, a media player application. Each of software applications 334 can include layout information defining the placement of particular fields and graphic elements (for example, text fields, input fields, icons, etc.) in the user interface that can correspond to the specific application.

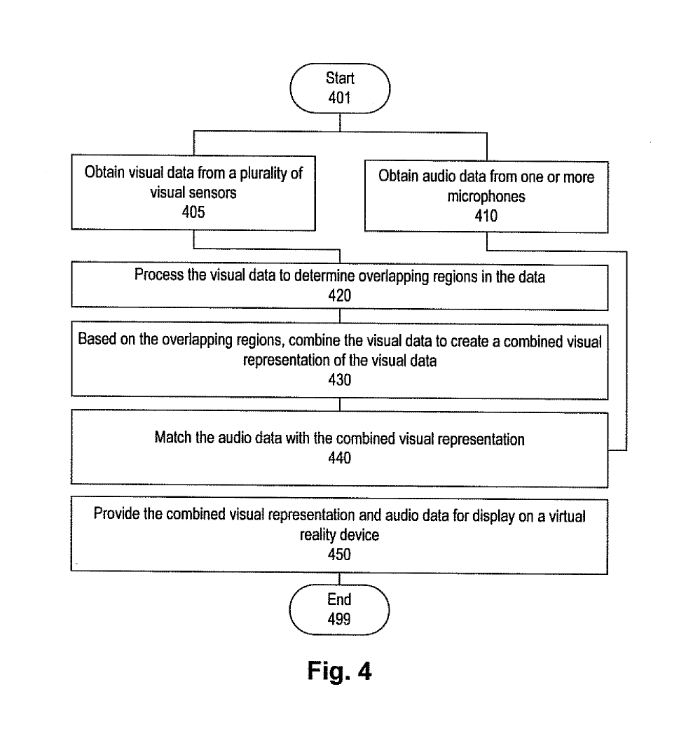

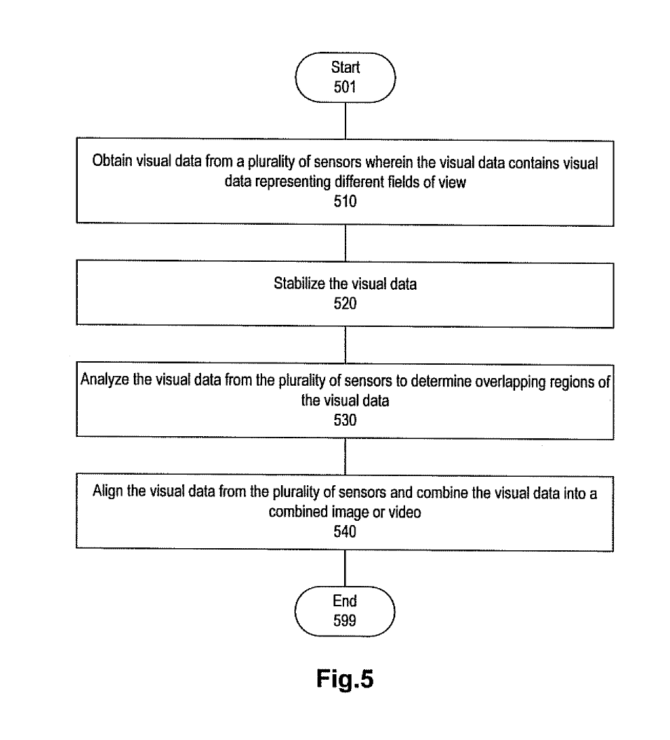

For example, an application, as described above, for processing the data captured by system 200 of FIG. 2, through Sensor 1, 202 and 206, Sensor 2, 213 and 218, and microphones 216 and 217) can display a graphical user interface elements described above to allow a user of electronic device 300 to interact with the captured data. The user can use the graphical elements to direct application 334 and processor 302 to combine the various data streams. At this direction, the application can process the various video and/or audio streams stored in the various memory modules of electronic device 300 and combine the various streams into a single 360 degree data stream. In some embodiments this data stream can include captured audio. The combined stream can be stored in the various memory devices provided by electronic device 300 and can be made available to other applications 334 executing on electronic device 300. Some steps of the algorithm performed by the application can be provided directly on electronic device 300, while some steps can be provided on an external module or device (e.g., a smart phone, desktop, laptop, or some specific external module or device for combining visual data). The specific algorithm and process used to stitch or combine the data streams is discussed in more detail in reference to FIGS. 4 and 5. Through the graphical user interface provided on display 306, the user can direct the creation of the 360 degree data stream. In some embodiments, the graphical user interface can be used to share images and videos on the Internet.

Applications 334 can include applications adapted to display 360 degree or virtual reality data streams. In some embodiments application 334 can be an algorithm that is part of one or more applications that executes on the various components of system 300. Additionally applications 334 can utilize the various subsystems of electronic device 300, such as communications subsystem 304 to share the 360 degree data stream with other devices or share the 360 degree data via the Internet using social networking or other platforms. Application 334 can be executed on either a mobile or non-mobile device. In some embodiments, a mobile application can allow a user to control the device, as well as download files from the glasses, stitch them on a device and upload to social networks or other platforms. In some embodiments, a desktop application can allow a user to download video files from the glasses and stitch them with basic editing functions. In some embodiments, a desktop application can allow a user to receive a normal video with a unique level of stabilization due to recorded movement data from an IMU or other sensors (e.g., accelerometer 220, gyroscope 221, compass 222, IMU 223, and other sensors 224 described in relation to FIG. 2), and to have the ability to change the angle and camera direction, in post-processing or while the full 360 degrees is filmed. The described functionality can be included in a single application or can be separated across multiple applications that run on the same device or on different devices. In some embodiments, the application can be divided into two parts. In a first part, the application can use an implementation of OpenCV, a generic programming language optimized for 3D graphic and 3D displays. to find matching objects in the various image and video streams. Because some exemplary parameters can be known or entered into the application in advance and the OpenCV implementation can create a physical model of the location of the 3D camera that represents the location and orientation of the glasses (e.g., glasses 101 from FIG. 1) in the scene.

In some embodiments the application can utilize technologies such as CUDA or OpenCL to execute directly on GPUs that can provide enhanced abilities to manipulate visual or graphical data. In other embodiments, the application can be implemented user shader libraries or definitions. Shaders can be used by the graphics process to allow for very specific control over the processing and display of each pixel that is part of the video or image stream.

In some embodiments, the application can include a model that uses a virtual camera representing glasses 101 that can allow for manipulation of the image and video data. For example, the application can provide rotation around the three axes of the camera and allow further modifications of the camera such as changes in focal length. By adjusting the 3 dimensional camera that represents glasses 101, the captured image or video streams can be modified using 3 dimensional graphics processing concepts. As the application changes the characteristics of the virtual camera, movement data captured by glasses 101 by accelerometer 220, gyroscope 221, compass 222, and IMU 223 discussed in FIGS. 1A-E can be used for stabilization due to changes in the model or other changes that result from changes to the model or camera.

In a second part of the algorithm, the image or video streams can be stitched. The application can use the model and project the stitched image onto a spherical object to represent the full image or scene surrounded the camera. This projection can includes blending the stitched areas.

Operating system software 332 can provide a number of application protocol interfaces (APIs) providing an interface for communicating between the various subsystems and services of electronic device 300, and software applications 334. For example, operating system software 332 provides a user interface API to any application that needs to create user interfaces for display on electronic device 300. Accessing the user interface API can provide the application with the functionality to create and manage screen windows and user interface controls, such as text boxes, buttons, and scrollbars; receive mouse and keyboard input; and other functionality intended for display on display 306. Furthermore, a communication API can allow a video or content processing application to access networked or remote devices for the purposes of acquiring image data, video data, and/or audio data (such as an image, video, and/or audio data that can be processed into combined 360 degree images for consumption in virtual reality or media player applications).

In some embodiments, persistent memory 310 stores data 336, including data specific to a user of electronic device 300, such as information of user accounts. Persistent memory 310 can also store data relating to those (e.g., contents, notifications, and messages) obtained from social networking services, data to be shared using the social networking services, or search results. Persistent memory 310 can further store data relating to various applications with preferences of the particular user of, for example, electronic device 300. In some embodiments, persistent memory 310 can store data 336 linking a user's data with a particular field of data in an application, such as for automatically entering a user's name into a username textbox on an application executing on electronic device 300. Furthermore, in various embodiments, data 336 can also include service data comprising information required by electronic device 300 to establish and maintain communication with a network.

In some embodiments, auxiliary input/output (I/O) subsystems 316 comprise an external communication link or interface, for example, an Ethernet connection. In some embodiments, auxiliary I/O subsystems 316 can further comprise one or more input devices, including a pointing or navigational tool such as a stylus, a clickable trackball or scroll wheel or thumbwheel, or a human finger; and one or more output devices, including a mechanical transducer such as a vibrator for providing vibratory notifications in response to various events on electronic device 300 (for example, receipt of a notification or a message or an incoming phone call), or for other purposes such as haptic feedback (touch feedback); or any combination thereof.

In some embodiments, electronic device 300 can also include one or more removable memory modules 338 (e.g., FLASH memory) and a memory interface 340. Removable memory module 338 can store information used to identify or authenticate a user or the user's account to a wireless network. For example, in conjunction with certain types of wireless networks, including GSM and successor networks, removable memory module 338 is referred to as a Subscriber Identity Module (SIM). Memory module 338 can be inserted in or coupled to memory module interface 340 of electronic device 300 in order to operate in conjunction with the wireless network.

Electronic device 300 can also include a battery 342, which furnishes energy for operating electronic device 300. Battery 342 can be coupled to the electrical circuitry of electronic device 300 through a battery interface 344, which can manage such functions as charging battery 342 from an external power source (not shown) and the distribution of energy to various loads within or coupled to electronic device 300.

A set of applications that control basic device operations, including data and possibly voice communication applications, can be installed on electronic device 300 during or after manufacture. Additional applications or upgrades to operating system software 332 or software applications 334 can also be loaded onto electronic device 300 through a wireless network, auxiliary I/O subsystem 316, data port 318, short-range wireless communication subsystem 326, or other suitable subsystem such as 328. The downloaded programs or code modules can be permanently installed, for example, written into the persistent memory 310, or written into and executed from RAM 312 for execution by processor 302 at runtime.

Electronic device 300 can provide three principal modes of communication: a data communication mode, a voice communication mode, and a video communication mode. In the data communication mode, a received data signal such as a text message, an e-mail message, Web page download, VoIP data, or an image, video, or audio file stream can be processed by communication subsystem 304 and input to processor 302 for further processing. For example, downloaded video streams can be further processed by a video editor to combine the data streams into a combined stream that can be output to display 306 or shared using communication subsystem 304 on, for example, social networks. A user of electronic device 300 can also compose data items, such as contents for sharing using social networking services, e-mail messages, for example, using the input devices, such as auxiliary I/O subsystem 316, in conjunction with display 306. These composed items can be transmitted through communication subsystem 304 over a wireless network and can include data processed by other applications or services, such as, video or image data processed by applications executing on processor 302. In the voice communication mode, electronic device 300 provides telephony functions and operates as a typical cellular phone. In the video communication mode, electronic device 300 provides video telephony functions and operates as a video teleconference terminal. In the video communication mode, electronic device 300 can utilize one or more cameras (such as camera 324) to capture video for the video teleconference. In some embodiments, electronic device 300 can control glasses 101 with support for live preview from one or more of the camera sensors (e.g., cameras 110, 111, 112, and 113 of FIG. 1).

FIG. 4 is a flowchart of an exemplary method 400 for capturing and processing content, consistent with embodiments of the present disclosure. It will be readily appreciated that the illustrated procedure can be altered to delete steps or further include additional steps. It is appreciated that one or more computing devices (such as the system of FIG. 2 or the electronic device of FIG. 3) can perform the exemplary method and that the functionality described herein can be incorporated as hardware, software stored in the one or more computing devices, or any combination thereof.

After initial step 401, the system (e.g. system 200 of FIG. 2) can obtain (step 405) visual data from each of the camera sensors (e.g., Sensor 1 202, Sensor 2 213, Sensor 1 206 and Sensor 2 218) that are associated with cameras (e.g., cameras 110, 111, 112, and 113 of FIG. 1) on the glasses (e.g., glasses 101 of FIG. 1). The data can stored in memory (e.g., SD Card 210 of FIG. 2).

Additionally, the system can obtain (step 410) audio data from the microphones (e.g., microphones 216 and 217 of FIG. 2). The data can be stored in memory (e.g., SD Card 210) along with the visual data.

The system can process (step 420) the various visual data streams to determine overlapping regions in the data. In some embodiments, the field of view of each of four camera sensors is 110 degrees. In these embodiments, because each camera captures 20 degrees more than the 90 degree field of view necessary to form a full 360 degree picture, there is an overlapping region of 10 degrees on each side of each data stream captured by each sensor. The overlapping regions for sets of cameras can be analyzed to line up each data stream. It is appreciated that in some embodiments more or less than four camera sensors can be used. In these embodiments, the size of the field of view can be adjusted to provide overlap among the captured video streams. In some embodiments, an overlap of at least 5 degrees among the captured video streams is used for the combination of the video streams.

In some embodiments, additional hardware features, such as accelerometers, gyroscopes, or other motion sensitive devices (e.g., accelerometer 220, gyroscope 221, compass 222, IMU 223, and other sensors 224) can provide additional information about the alignment and arrangement of the various visual data streams as mentioned in relation to FIG. 1A-E. Additional hardware components can be included that might not be shown in FIG. 2. In some embodiments, more or less cameras are used to capture visual data with overlapping regions.

The system, based on the overlapping regions determined in step 420 can combine (step 430) the visual data. Overlap between each image allows for stitching the visual data streams together both in a horizontal and vertical direction. The visual data streams can be stitched together to create a 360 degree field of view for a combined visual representation of the scene and the vertical image can be stitched together to create at least a 250 degree field of view for a combined visual representation. The resulting stitched image is similar to a dome or sphere that represents the full field of view of the captured scene. In some embodiments, combining the visual data can occur on a server or device separate from the device capturing the video content. In these embodiments the separate visual data can be provided to the external system or device for combining.

In some embodiments, the system can utilize concepts used by graphics processing units and three dimensional graphic transformations to align and combine the various data streams. For example, the system can utilize technologies such as CUDA, OpenCL, and libraries like OpenCV. In some embodiments, the system can utilize shaders (both pixel and vertex shaders), which allow processing directly on the graphics processing units to calculate the alignment, orientation, combination, and various other characteristics for combining the data stream and for providing warping and blending.

The system can match (step 440) audio data with the combined visual data or, in some embodiments, the separate visual data streams. The audio data can be synchronized with the visual data streams using the synchronization mechanisms described in relation to FIG. 2. As previously described, the audio data can include multiple audio channels and can provide, mono, stereo, or surround sound in combination with the video data stream. In some embodiments, various microphones can be adapted to capture specific frequencies or ranges of audio that can be combined to create dynamic range audio in combination with the video data stream.

The system can then provide (step 450) the combined data visual representation and audio data for display on a virtual reality device. In some embodiments, the combined visual representation and audio data can be provided directly from the device through live streaming. The live-streaming process can utilize a Wi-Fi or wireless module (e.g., wireless module 201 of FIG. 2 or a GSM module), a cable connection to an external communication module (e.g., through USB Device 214 of FIG. 2), or through other methods of communication. The combined visual representation and audio data can be provided to a server that allows users to connect to view and listen to the provided content. In some embodiments, the system can stream or provide the combined representation and audio data directly to devices designed to consume the content. The quality of the combined visual representation can further be adjusted to account for varying capabilities of the devices and servers receiving the combined visual representation and audio data.

As previously described, some steps of the algorithm can be provided directly on the device, while some steps can be provided on an external module or device (e.g., a smart phone, desktop, laptop, or some specific external module for combining visual data).

Furthermore, the virtual reality device can include consumer level mobile devices, phones, or other devices adapted to display virtual reality content. In some embodiments, the display can provide only a limited field of view. A subsection of the video data can be displayed on such a display device and a controller or other device can be used to pan the limited display around the scene. In other embodiments, a non-virtual reality display can display a fixed field of view of the combined visual stream. FIG. 5 is a flowchart of an exemplary method for capturing content, consistent with embodiments of the present disclosure. It will be readily appreciated that the illustrated procedure can be altered to delete steps or further include additional steps. It is appreciated that one or more computing devices (such as the system of FIG. 2 or the electronic device of FIG. 3) can perform the exemplary method and that the functionality described herein can be incorporated as hardware, software stored in the one or more computing devices, or any combination thereof.

After initial step 501, the system (e.g. system 200 of FIG. 2) can obtain (step 510) visual data from each of the camera sensors (e.g., Sensor 1 202, Sensor 2 213, Sensor 1 206 and Sensor 2 218) that are associated with cameras (e.g., cameras 110, 111, 112, and 113 of FIG. 1) on the glasses (e.g., glasses 101 of FIG. 1). The system, using the application or algorithm discussed in FIG. 3, can obtain visual data representing different fields of view. The data can be stored in memory (e.g., SD Card 210).

The system, can stabilize (step 520) the various visual data streams obtained to correct for, among other things, jitter, shaking, and/or jerky movement of the camera sensors (e.g., Sensor 1 202, Sensor 2 213, Sensor 1 206 and Sensor 2 218). In some embodiments, additional hardware features, such as accelerometers, gyroscopes, or other motion sensitive devices can provide additional information about the alignment and arrangement of the various visual data streams for stabilization. The system can utilize measurements from, for example, accelerometer 220, gyroscope 221, compass 222, IMU 223, and other sensors 224 from FIG. 1A-E.

The system can analyze (530) the various visual data streams from the plurality of sensors to determine overlapping regions in the visual data. In some embodiments, the field of view of each of four camera sensors is 110 degrees. In these embodiments, because each camera captures 20 degrees more than the 90 degree field of view necessary to form a full 360 degree picture, there is an overlapping region of 10 degrees on each side of each data stream captured by each sensor. The overlapping regions for sets of cameras can be analyzed to line up each data stream. In some embodiments, more or less cameras are used to capture visual data with overlapping regions. It is appreciated that in some embodiments more or less than four camera sensors can be used. In these embodiments, the size of the field of view can be adjusted to provide overlap among the captured video streams. In some embodiments, an overlap of at least 5 degrees among the captured video streams is used for the combination of the video streams.

The system can align (step 540) the visual data into a combined image or video based on the overlapping regions determined in step 530. Overlap between each image allows for stitching the visual data streams together both in a horizontal and vertical direction. The visual data streams can be stitched together to create a 360 degree horizontal field of view, and the vertical image can be stitched together to create at least a 250 degree field of view for a combined visual representation. The resulting stitched image can be similar to a dome or sphere that represents the full field of view of the captured scene. In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only. It is also intended that the sequence of steps shown in figures are only for illustrative purposes and are not intended to be limited to any particular sequence of steps. As such, those skilled in the art can appreciate that these steps can be performed in a different order while implementing the same method.

1. An apparatus for capturing visual data for virtual reality systems comprising:
a housing member containing a plurality of visual sensors, wherein each visual sensor of the plurality of visual sensors is oriented to capture a field of view different from the other visual sensors of the plurality of visual sensors of the plurality of visual sensors;
a memory for storing visual data;
one or more processors executing one or more programs configured to:
acquire the visual data captured by the plurality of visual sensors;
store the acquired visual data in the memory; and
provide the visual data stored in the memory for combining into a combined visual representation of the visual data wherein the combined visual representation of the visual data is based on:
a synchronization of the visual data;
a determination of matching portions of the fields of view contained in the visual data based on overlapping regions in the visual data; and
based on the matching portions of the fields of view, an alignment and combining of the fields of view.

2. The apparatus of claim 1, wherein the housing member is adapted to be worn on a head.

3. The apparatus of claim 2, wherein the housing member is one of sunglasses, sport goggles, a helmet, a hat, headgear, and a headband.

4. The apparatus of claim 1, further comprising:
one or more motion sensors wherein the visual data is stabilized based on data acquired from the one or more motion sensors and the visual data.

5. The apparatus of claim 1 further comprising:
one or more microphones for capturing audio data, wherein the audio data is synchronized with the visual data and is provided for combining with the combined visual representation of the visual data.

6. The apparatus of claim 1, wherein each field of view is at least 110 degrees in a horizontal direction and is at least 110 degrees in a vertical direction.

7. The apparatus of claim 1, wherein the combined visual representation includes a 360 degree field of view in a horizontal direction and at least a 250 degree field of view in a vertical direction.

8. The apparatus of claim 1, wherein the visual data is provided from the apparatus to a computing device, wherein the computing device generates the combined visual representation of the visual data.

9. The apparatus of claim 1, wherein the combined visual representation is further provided for display in a virtual reality system.

10. The apparatus of claim 1, wherein the visual data is provided over a wireless communication channel.

11. A system for combining visual data, the system comprising:
a memory for storing the visual data;
one or more processors configured to:
acquire visual data containing one or more different fields of view captured using visual sensors;
synchronize the visual data based on information provided with the visual data;
determine matching portions of the fields of view based on an analysis of the visual data wherein the analysis is based on overlapping regions in the visual data; and
combine the fields of view into a combined visual representation of the visual data based on the determination.

12. The system of claim 11, wherein the one or more processors are further configured to stabilize the visual data based on an analysis of the visual data.

13. The system of claim 12, wherein the one or more processors are further configured to acquire synchronization information provided with the visual data, wherein the stabilization of the visual data and the determination is further based on the synchronization information.

14. The system of claim 11, wherein the one or more processors are further configured to acquire audio data captured using at least one microphone and combine the audio data with the combined visual representation of the visual data.

15. The system of claim 11, wherein the one or more processors are further configured to acquire motion sensor information provided with the visual data, wherein the stabilization of the visual data is based on the motion sensor information.

16. The system of claim 11, wherein the system is a mobile computing device.

17. A non-transitory computer readable storage medium storing instructions that are executable by a first computing device that includes one or more processors to cause the first computing device to perform a method comprising:
acquiring visual data captured by a plurality of visual sensors wherein each visual sensor of the plurality of visual sensors is oriented to capture a field of view different from the other visual sensors of the plurality of visual sensors;
providing the acquired visual data for combining into a combined visual representation of the visual data wherein the combined visual representation of the visual data is based on:
a synchronization of the visual data;
a determination of matching portions of the fields of view contained in the visual data wherein the analysis is based on overlapping regions in the visual data; and
based on the matching portions of the fields of view, an alignment and combining of the fields of view.

18. The non-transitory computer readable storage medium of claim 17 wherein the instructions that are executable by the first computing device further cause the first computing device to perform:
stabilizing the visual data based on data acquired from one or more motion sensors and the visual data.

19. The non-transitory computer readable storage medium of claim 17, wherein the instructions that are executable by the first computing device further cause the first computing device to perform:
capturing audio data;
synchronizing the audio data with the visual data; and
providing the audio data for combining with the combined visual representation of the visual data.

20. The non-transitory computer readable storage medium claim 17, wherein the visual data is provided from the apparatus to a computing device, wherein the computing device generates the combined visual representation of the visual data.
